(19) United States
(12) Patent Application Publication
(10) Pub. No.: US 2003/0090023 A1
(43) Pub. Date: May 15, 2003

(54) Method of manufacturing composite molded product, including coating for insert material with dope cement before insert molding

(76) Inventors: Satoshi Suzuki, Hamamatsu-shi (JP); Hisayoshi Osumi, Shuchi-gun (JP); Sunao Ishizuka, Inasa-gun (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/073,102

(22) Filed: Feb. 12, 2002

(30) Foreign Application Priority Data
Feb. 13, 2001 (JP) P2001-036124

(51) Int. Cl. B29C 45/14

(52) U.S. Cl. 264/129; 264/255; 264/265

(57) ABSTRACT

A method of manufacturing a composite molded product is disclosed, so as to improve the adhesion between the insert material and the base resin. The method comprises the steps of coating an insert material with primer; coating surface of the primer with dope cement; and subjecting the insert material coated with the dope cement to insert molding. The adhesion between the insert material and the base resin is superior; thus, substandard products having a portion which breaks away or protrudes are hardly generated. In addition, a surface material in which the insert material is coated with the dope cement has a very small degree of camber; thus, punching or the like for shaping the surface material can be easily performed after the coating.

### BACKGROUND OF THE INVENTION

1. Field of the Invention

The present invention relates to a method of manufacturing a composite molded product, so as to improve the adhesion between a synthetic resin and an insert material such as metal, resin, inorganic material, or the like, in the insert molding.

2. Description of the Related Art

Conventionally, composite molded products, each consisting of (i) a smooth wood panel having a top wood layer and (ii) a synthetic-resin core material, are used as materials for quality furniture or the interior of deluxe cars.

Additionally, in fields such as that of sound-damping and sound-insulating materials, composite steel plates, and various kinds of shielding materials, and in particular, in the fields such as those involving the adhesion between steel plates and the adhesion and composition of a steel plate and a plastic material, use of a plastic outside plate has been examined so as to improve the weatherability and to reduce the weight and the cost.

In order to obtain such composite molded products, insert molding is typically performed in which (i) an insert material as a top layer, which is made of metal, synthetic resin, inorganic material, or the like, is prepared, (ii) the back face of the insert material is coated with primer, and (iii) this insert material is installed in a mold of the injection molding so as to inject synthetic resin and mold a synthetic resin base at the back-face side of the insert material.

However, in this method, the time during which the primer is maintained to be active is short. Therefore, the injection molding should be executed in a very short time after the coating using the primer is performed. Additionally, such coating using the primer must be performed immediately before the insert molding. Therefore, it is difficult to uniformly coat an insert material with primer if the shape of a product to be manufactured is complicated. Also in this method, adhesion between the insert material and the base resin is inferior; thus, molded products may have a portion which breaks away or protrudes.

### SUMMARY OF THE INVENTION

In consideration of the above circumstances, an object of the present invention is to provide a method of manufacturing a composite molded product, so as to improve the adhesion between the insert material and the base resin.

Therefore, the present invention provides a method of manufacturing a composite molded product, comprising the steps of:

coating an insert material with dope cement; and

subjecting the insert material coated with the dope cement to insert molding.

The present invention also provides a method of manufacturing a composite molded product, comprising the steps of:

coating an insert material with primer;

coating surface of the primer with dope cement; and

subjecting the insert material coated with the dope cement to insert molding.

In the above methods, typically, the dope cement is obtained by dissolving a synthetic resin in a solvent, where the synthetic resin is injected synthetic resin in the insert molding or synthetic resin which has compatibility with the injected synthetic resin.

According to the present invention, adhesion between the insert material and the base resin is superior; thus, substandard products having a portion which breaks away or protrudes are hardly generated. In addition, a surface material in which the insert material is coated with the dope cement has a very small degree of camber; thus, punching or the like for shaping the surface material can be easily performed after the coating.

Furthermore, according to the dope cement, sufficient time can be obtained before the start of injection molding. Therefore, even if the shape of a product to be manufactured is complicated, the plate before forming the shape can be uniformly coated with the dope cement. In addition, the plate after the coating has a very small degree of camber; thus, punching or the like for shaping the plate can be easily performed.

The present invention also provides a method of manufacturing a composite product, comprising the steps of:

applying a solution, which comprises a first synthetic resin and a solvent, over a substrate to form a first layer comprising said first synthetic resin; and

forming a second layer, which comprises a second synthetic resin compatible with said first synthetic resin, on said first layer.

This method may further comprise the step of removing said solvent to form said first layer over said substrate, or the step of coating the surface of said substrate with primer.

In the above method, said second layer may be formed on said first layer by injection molding. Typically, said substrate is made of as least one material selected from metal, resin, and inorganic material.

### BRIEF DESCRIPTION OF THE DRAWINGS

FIG. 1 is a general cross-sectional view showing the structure of an example of the composite molded product manufactured by using the manufacturing method according to the present invention.

FIG. 2 is a general cross-sectional view showing an example of the arrangement in which the surface material is installed in the cavity of a mold used in the injection molding, according to the present invention.

### DESCRIPTION OF THE PREFERRED EMBODIMENTS

Hereinafter, embodiments according to the present invention will be explained in detail.

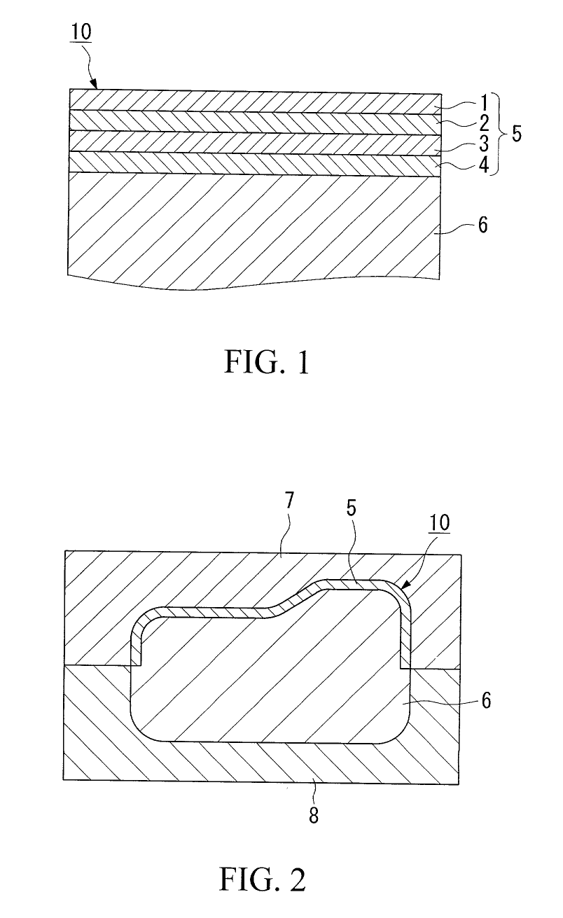

FIG. 1 is a general cross-sectional view showing the structure of an example of the composite molded product manufactured by using the manufacturing method according to the present invention.

In the figure, reference numeral 1 indicates an insert material. This insert material 1 is formed in advance to have a shape corresponding to the mold used in the insert molding, that is, a shape approximately corresponding to a final composite product. One of the surfaces of the insert material 1 is treated to form a surface-treated layer 2. This surface-treated layer 2 is coated with primer to have a primer film 3. The primer film 3 is then coated with dope cement to have a dope cement film 4, so that a surface material 5 is obtained.

In the present invention, the surface-treated layer 2 and the primer film 3 may be omitted.

As shown in FIG. 2, the surface material 5 is installed in the cavity of a mold 7 used in the injection molding in a manner such that the dope cement film 4 faces the cavity (i.e., the insert material 1 faces the wall of the mold 7). The shape of the cavity in the mold 7 corresponds to the shape of a final molded product. Then the injection molding is executed so as to inject synthetic resin towards the dope cement film 4 of the surface material 5, thereby combining the synthetic resin and the surface material 5. This composite is then taken out from the molds 7 and 8 of the injection molding, so that a composite molded product 10 consisting of the surface material 5 and a base resin layer 6 is obtained.

The insert material 1 in the present embodiment is metal, resin, inorganic material, or the like.

Typically, aluminum, aluminum alloy, stainless steel, carbon steel, or copper may be used as the metal.

As the resin, polycarbonate, polyester/polycarbonate, polyethylene, polypropylene, polyethylene terephthalate, poly(methyl methacrylate), or the like, may be used.

As the inorganic material, alumina, glass, ceramics, concrete, natural stone, or the like, may be used.

At least one of the surfaces of the insert material I is treated so as to improve the adhesion, thereby forming the surface-treated layer 2. When the insert material 1 is metal, the surface treatment (method) called Alumite, Alodine (Alocrom), etching, or the like, may be employed. When the insert material 1 is resin or inorganic material, sanding, shot blasting, or the like, may be employed as the surface treatment.

Here, even if the surface treatment is omitted in the present invention, the dope cement film 4 provides sufficient strength of adhesion between the insert material 1 and the base resin layer 6.

The primer in the present embodiment may be epoxy, urethane, rubber, acrylic, polypropylene, or vinyl paint (or coating). Such paint is generally used in adhesion, painting, coating, laminating, or composition applied to aluminum, aluminum alloy, stainless steel, carbon steel, copper, polycarbonate, polyester/polycarbonate, polyethylene, polypropylene, polyethylene terephthalate, poly(methyl methacrylate), alumina, glass, ceramics, concrete, or the like.

A concrete example of the epoxy primer is two-liquid epoxy primer having major components of (i) multifunctional epoxy resin such as cyclic fatty acid epoxy resin, glycerin-type epoxy resin, dimer acid modified epoxy resin, or a reactant between bisphenol A and epichlorohydrin, and (ii) polyamine such as polyaminoamide compound, aliphatic polyamine, cyclic aliphatic polyamine, or aromatic polyamine.

The following are concrete examples of the urethane primer: two-liquid urethane primer having major components of (i) multifunctional polyisocyanate which is a multifunctional polyisocyanate compound having an isocyanate group at the end, and (ii) polyol such as polyether polyol or polycarbonate polyol, and single-liquid urethane primer having a major component of multifunctional polyisocyanate.

The following are concrete examples of the rubber primer: natural rubber, styrene-butadiene rubber, polybutadiene rubber, polyisobutylene, polychloroprene, polyacrylate rubber, and polyvinyl ether rubber.

The following are concrete examples of the acrylic primer: multifunctional methacrylic acid ester and multifunctional acrylic acid ester.

The following are concrete examples of the polypropylene primer: polypropylene and chlorinated polypropylene.

The following are concrete examples of the vinyl primer: polyvinyl butyral, polyvinyl formal, polyvinyl acetacetal, and vinyl ether such as divinyl ether or dibutylvinyl ether.

The insert material 1 or the surface-treated layer 2 is coated with one or more layers of such primer. The method such as printing, spraying, rolling, or flow coating can be employed for the coating with the primer.

The surface coated with the primer is dried at a temperature from room temperature to 50° C., thereby forming the primer film 3. The thickness of the primer film 3 is 1 to 100 μm, preferably, 5 to 20 μm.

The dope cement used in the present embodiment is a solution obtained by dissolving a synthetic resin in a solvent, where this synthetic resin is one used for the base resin layer 6 or one having compatibility with the base resin layer 6. Such dope cement has very superior adhesion with respect to the insert material 1 as an adherend.

The following are concrete examples of the above synthetic resin: (i) styrene resin such as acrylonitrile-butadiene-styrene copolymer (abbreviated as “ABS” hereinbelow), acrylonitrile-styrene copolymer (abbreviated as “AS” hereinbelow), or polystyrene, (ii) vinyl polymer resin such as polyvinyl chloride or polyvinylidene chloride, (iii) acrylic resin such as polymethyl methacrylate, (iv) polycarbonate resin, (v) polyamide resin, (vi) polyolefin resin such as polyethylene or polypropylene, and (vii) polyester resin such as polyethylene terephthalate or polybutylene terephtalate. These kinds of resin are used alone or in a mixture in which two or more kinds of resin are mixed. If difficult-to-dissolve synthetic resin such as polyethylene is used, powder of this synthetic resin is suspended or mixed with easily-soluble synthetic resin such as ABS resin.

The solvent may be acetone, methanol, isopropanol, toluene, xylene, methyl acetate, isobutyl acetate, butyl acetate, methyl ethyl ketone, or methyl isobutyl ketone. These kinds of solvents are used in a single kind or a mixture, according to the kind of the synthetic resin which is dissolved in the solvent.

The insert material 1 may be directly coated with such dope cement, or the surface-treated layer 2 may be coated with the dope cement, or the primer film 3 may be coated with the dope cement. The coated portion is then dried in an atmosphere at a temperature from room temperature to 50° C., thereby forming the dope cement film 4. Similar to the primer, the method such as printing, spraying, rolling, or flow coating can be employed for the coating with the dope cement.

The thickness of the dope cement film 4 is 5 μm or more, preferably, 25 to 70 μm.

The following are concrete examples of the synthetic resin of which the base resin layer 6 is made: (i) styrene resin such as acrylonitrile-butadiene-styrene copolymer (abbreviated as “ABS” hereinbelow), acrylonitrile-styrene copolymer (abbreviated as “AS” hereinbelow), or polystyrene, (ii) vinyl polymer resin such as polyvinyl chloride or polyvinylidene chloride, (iii) acrylic resin such as polymethyl methacrylate, (iv) polycarbonate resin, (v) polyamide resin, (vi) polyolefin resin such as polyethylene or polypropylene, and (vii) polyester resin such as polyethylene terephthalate or polybutylene terephtalate. These kinds of resin are used alone or in a mixture in which two or more kinds of resin are mixed.

As the dope cement film 4 has compatibility with the base resin layer 6, the degree of adhesion between the dope cement and the base resin is superior regardless of the elapsed time, that is, even after a few hours or days passed. In addition, after the insert material 1 having a plate shape is coated with dope cement and is then dried, the plate can be subjected to blanking or press working so as to form a desired shape. Therefore, even if the shape of the surface material 5 is complicated, the plate before forming the shape can be uniformly coated with the dope cement.

The various combinations between the insert material, surface treatment, primer, dope cement, solvent, and base resin are possible as shown in Table 1.

TABLE 1

| | | | | dope cement | | |
|---|---|---|---|---|---|---|
| insert material | | treatment | primer | resin | solvent | base resin |
| metal | aluminum | Alumite | epoxy | ABS | acetone | ABS |
| plate | | Alodine | urethane | AS | methanol | AS |
| | | etching | rubber | polystyrene | isopropanol | polystyrene |
| | stainless | etching | poly- | poly(vinyl | toluene | poly(vinyl |
| | steel | | propylene | chloride) | xylene | chloride) |
| | copper | etching | vinyl | acrylic | methyl | acrylic |
| resin | PPS | sanding | epoxy | poly- | acetate | poly- |
| | | shot blasting | urethane | carbonate | isobutyl | carbonate |
| | FRP | sanding | acrylic | polyamide | acetate | polyamide |
| | | shot blasting | poly- | | butyl acetate | |
| | | | propylene | | methyl ethyl | |
| | | | vinyl | | ketone | |
| inorganic | alumina | sanding | epoxy | | methyl | |
| material | | shot blasting | rubber | | isobutyl | |
| | glass | sanding | poly- | | ketone | |
| | | shot blasting | propylene | | | |
| | stone | sanding | vinyl | | | |
| | | shot blasting | | | | |

The composite molded product 10 formed by the process as explained above has sufficient adhesion between the insert material 1 and the base resin layer 6; thus, substandard products having a portion which breaks away or protrudes are hardly generated. In addition, the surface material 5 in which the insert material 1 is coated with the dope cement 4 has a very small degree of camber; thus, punching or the like for shaping the surface material 5 can be easily performed after the coating.

Below, practical examples will be explained.

First, the dope cement was made under the following conditions: 40 g of ABS resin (product name: Stylac-ABS, manufactured by Asahi Kasei Corporation) pellets was dissolved in 100 g of acetone. This solution was diluted with the same amount of toluene, thereby making the dope cement.

In the next step, after a surface-treated face of an aluminum thin plate having a thickness of 0.5 mm was coated with primer, the coated face was further coated with the above dope cement. The coated face was then dried, so that a dope cement film was formed.

Similar processes were repeated for different kinds of primer, and for different thicknesses (μm) of the dope cement. After the coating with the dope cement, each aluminum thin plate was left to stand for one or more days or months at ordinary temperature. The aluminum thin plate was then installed in the cavity of a mold used in the injection molding, and ABS resin (product name: Stylac-ABS, manufactured by Asahi Kasei Corporation) for forming the base resin layer was injected into the mold, so that a composite molded product was obtained.

The strength of adhesion between the aluminum thin plate and the base resin layer of each composite molded product was measured. The results of measurement are shown in Table 2.

TABLE 2

| | | thickness of | | | adhesion |
|---|---|---|---|---|---|
| | | dope cement | elapsed time | | strength |
| primer | dope cement | film (μm) | after coating | | (MPa) |
| vinyl + | ABS | 70 | one | day | 13.5 or more |
| urethane | | | one | month | (rupture at |
| (double | | | three | months | ABS layer) |
| layer) | no | — | 0 | days | 3.9 |
| | dope cement | | one | day | 0.9 |
| | ABS | 25 | | | 8.7 |
| | | 15 | | | 4.4 |
| | | 10 | | | 3.5 |
| | | 5 | | | 2.9 |
| poly- | | 70 | | | 13.5 or more |
| propylene + | | 45 | | | (rupture at |
| urethane | | 25 | | | ABS layer) |
| (double | | | | | |
| layer) | | | | | |
| poly- | | 70 | | | 13.5 or more |
| propylene | | 45 | | | (rupture at |
| (single | | | | | ABS layer) |
| layer) | | 25 | | | 11.0 |
| no primer | | 70 | | | no adhesion |

With reference to Table 2, each composite molded product using the primer and the dope cement, in which the thickness of the dope cement is 25 to 70 μm, maintains sufficient adhesion even when one or more days or months have passed after the coating with the dope cement.

The insert material 1 may be made of wood. In this case, (i) the surface treatment called sanding may be used, or no surface treatment may be performed, (ii) the primer is not always necessary (i.e., may be used), (iii) dope cement as explained above may be used, and (iv) synthetic resin as explained above may be used for a base resin layer.

Although the invention has been described in detail herein with reference to its preferred embodiments and certain described alternatives, it is to be understood that this description is by way of example only, and it is not to be construed in a limiting sense. It is further understood that numerous changes in the details of the embodiments of the invention, and additional embodiments of the invention, will be apparent to, and may be made by, persons of ordinary skill in the art having reference to this description. It is contemplated that all such changes and additional embodiments are within the spirit and true scope of the invention as claimed.

What is claimed is:

1. A method of manufacturing a composite molded product, comprising the steps of:
coating an insert material with dope cement; and
subjecting the insert material coated with the dope cement to insert molding.

2. A method of manufacturing a composite molded product, comprising the steps of:
coating an insert material with primer;
coating surface of the primer with dope cement; and
subjecting the insert material coated with the dope cement to insert molding.

3. A method of manufacturing a composite molded product, as claimed in claim 1, wherein the dope cement is obtained by dissolving a synthetic resin in a solvent, where the synthetic resin is injected synthetic resin in the insert molding or synthetic resin which has compatibility with the injected synthetic resin.

4. A method of manufacturing a composite molded product, as claimed in claim 2, wherein the dope cement is obtained by dissolving a synthetic resin in a solvent, where the synthetic resin is injected synthetic resin in the insert molding or synthetic resin which has compatibility with the injected synthetic resin.

5. A method of manufacturing a composite product, comprising the steps of:
applying a solution, which comprises a first synthetic resin and a solvent, over a substrate to form a first layer comprising said first synthetic resin; and
forming a second layer, which comprises a second synthetic resin compatible with said first synthetic resin, on said first layer.

6. A method of manufacturing a composite product, as claimed in claim 5, further comprising the step of:
removing said solvent to form said first layer over said substrate.

7. A method of manufacturing a composite product, as claimed in claim 5, further comprising the step of:
coating the surface of said substrate with primer.

8. A method of manufacturing a composite product, as claimed in claim 5, wherein said second layer is formed on said first layer by injection molding.

9. A method of manufacturing a composite product, as claimed in claim 5, wherein said substrate is made of as least one material selected from metal, resin, and inorganic material.
